(19) United States
(12) Patent Application Publication
(10) Pub. No.: US 2010/0301076 A1
(43) Pub. Date: Dec. 2, 2010

(54) Adhesive footwear

(76) Inventor: Adam Paul Cross, Lafayette, LA (US)

Correspondence Address: Adam Paul Cross, Apt. 3D, 101 Michael Allen Blvd., Lafayette, LA, 70501, US

(21) Appl. No.: 12/804,964

(22) Filed: Aug. 3, 2010

(51) Int. Cl. A47G 25/80; A43D 11/00; B32B 37/12

(52) U.S. Cl. 223/113; 12/1 R; 156/60

(57) ABSTRACT

This invention is a type of adhesive footwear for humans. The adhesive bond between the footwear and foot eliminates the need for shoestrings, Velcro, zippers, or any other type of fastening device. Unlike other types of footwear, the adhesive bond enables the footwear to remain in place and causes less discomfort when the foot becomes wet, sandy, or muddy. The footwear is precut into a shape that makes it capable of fitting several different sizes and types of feet. It is applied to the feet by stepping directly onto the adhesive side of the slip resistant material. Only the material needed will remain attached to the foot, making the footwear as light as possible.

### CROSS REFERENCES TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF INVENTION

People are constantly coming up with new and inventive water activities. As a result, many people are frequently injured from the associated hazards; many of which, involve injuries to the feet. While the current water shoes may offer some protection against puncturing and slipping, they also create other annoyances when wet, sandy, and/or muddy. In most cases, current water shoes create more discomforts than they help eliminate. As a result, many patrons of water activities remove their footwear before getting wet.

Two of the most common types of footwear seen around pools and beaches are flip-flops and sandals. Both types of footwear must be removed before getting wet. Most flip-flops and sandals become so slippery if they get wet that it is difficult to walk or even stand, without falling.

### BRIEF SUMMARY OF INVENTION

The proposed invention solves the problems associated with sand, mud, and water by creating an adhesive bond to the bottom of the foot in such a way that no other means of support are necessary to keep the footwear in place. The adhesion forms a barrier between the foot and footwear, keeping water, sand, and mud out. This type of bond eliminates chafing because the foot and footwear do not rub up against each other. This new type of footwear feels more natural because it does not inhibit the foot's natural abilities, but still protects the feet from becoming worn and blistered.

The invention capitalizes on this new method of adhering footwear in place by precutting the sheet of slip-resistant material into a shape that makes the footwear only bond to the parts of the foot that need protection. The precut shapes also make the footwear capable of fitting many different shoe sizes. It also minimizes the amount of weighted material bonded to the foot, and makes the footwear capable of being worn in sand, water, and mud without creating a nuisance.

### DESCRIPTION OF VIEWS

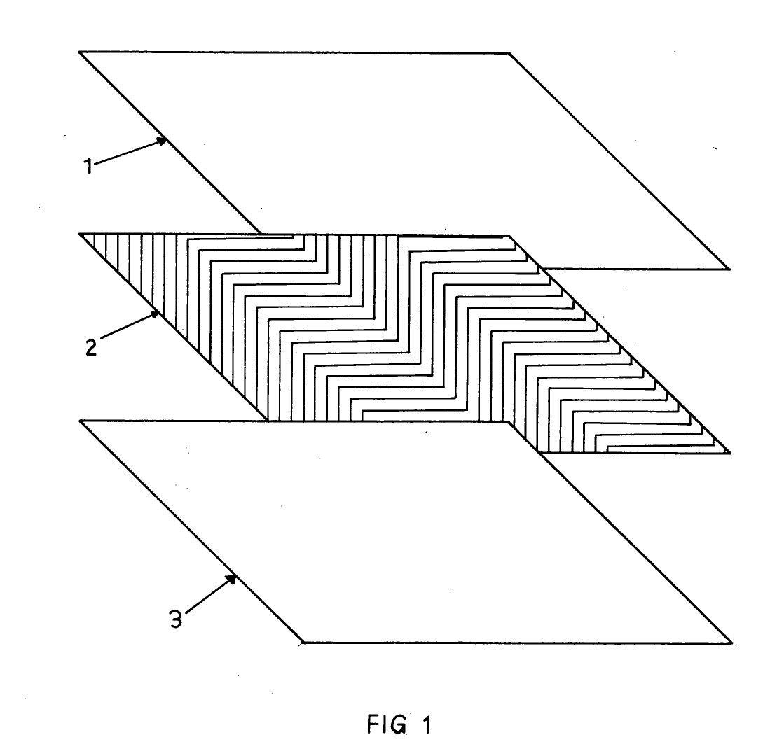

(FIG. 1) is an exploded perspective, bottom view of the footwear.

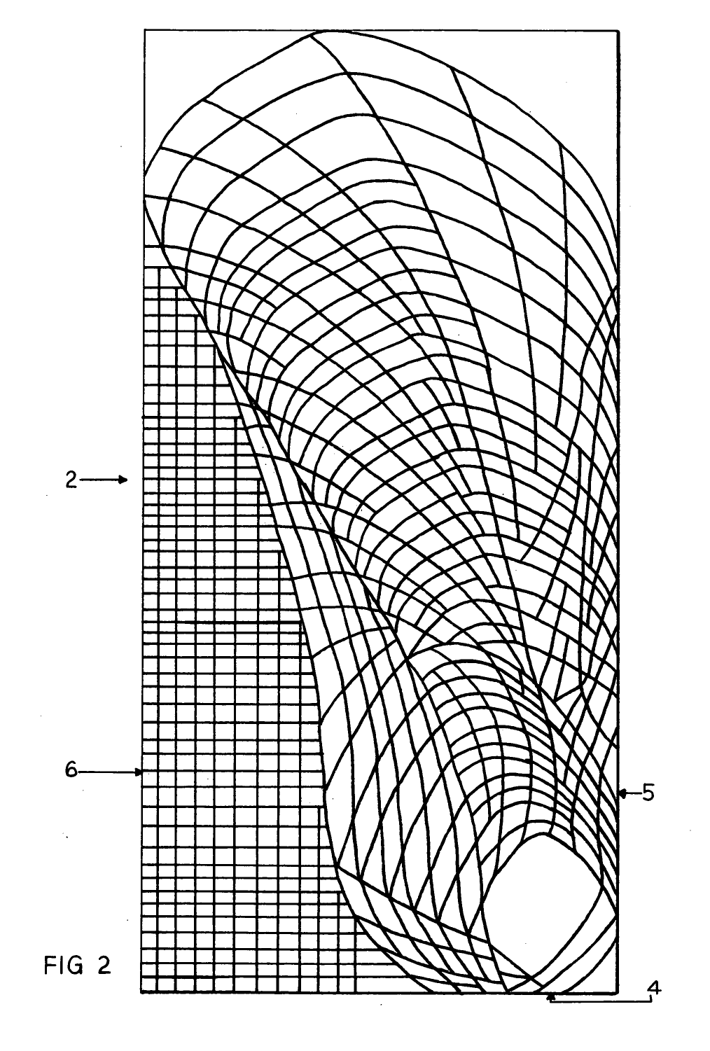

(FIG. 2) is a top view of (2).

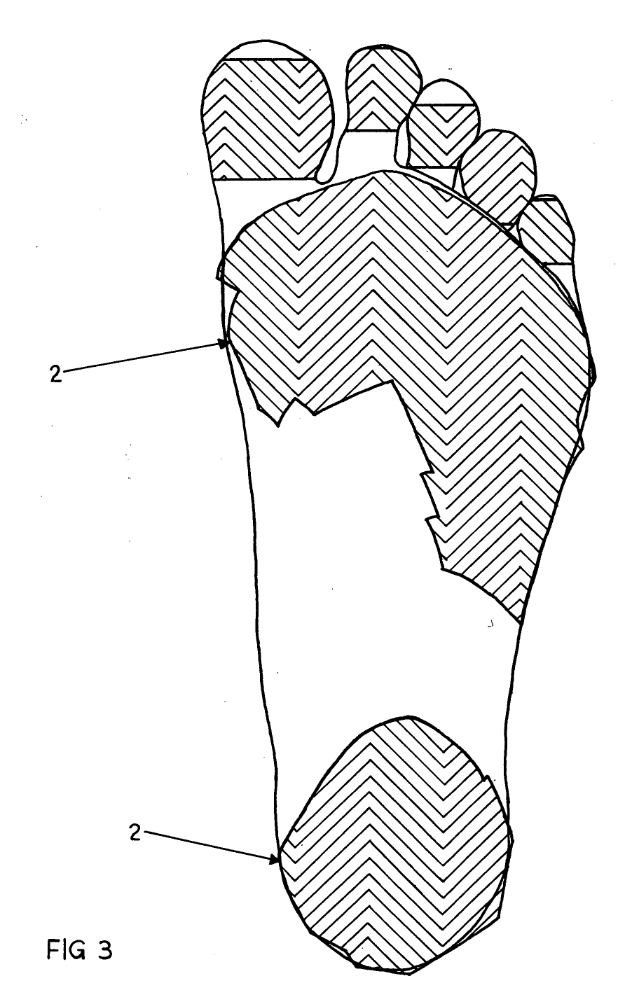

(FIG. 3) is a bottom view of (2) attached to a foot.

### DETAILED DESCRIPTION OF THE INVENTION

There are three distinct sheets of material (FIG. 1). The goal of sheet 1 is to protect the adhesive side of sheet 2. Sheet 2 is made of a slip resistant material with a slip resistant texture on one side and an adhesive coating on the other side. Sheet 2 is precut into a shape (FIG. 2) that enables the footwear to fit several different size feet. The tacky surface of sheet 3 keeps the unneeded pieces of sheet 2 from becoming attached to the foot. The bond between sheet 2 and 3 is weaker than the bond created between sheet 2 and skin.

The invention is first applied by cleaning the foot in which the user intends to apply the footwear. Once the foot is clean and dry, sheet 1 is removed from sheet 2. The user must then place their heel onto sheet 2 as close to the corner of lines 4 and 5 as possible, but without crossing over lines 4 and 5. Once the heel is in place, the user presses down on sheet 2 along line 5, but without crossing over line 5. The footwear can be applied to the toes by rolling each toe along the edge (6) of sheet 2. Now that the footwear has been applied, sheet 3 can be discarded along with the pieces of sheet 2 that remain attached to sheet 3.

To remove the footwear, the user simply pulls the pieces of sheet (2) off of their feet.

1. The use of adhesives to create a bond between a foot and a piece of material as a means of creating footwear for purposes other than bandaging wounds.

2. Precutting and/or shaping material as illustrated in (FIG. 2) for the purpose of making footwear capable of fitting several shoe sizes.

3. The method in which the footwear is applied as described.
